(19) United States
(12) Patent Application Publication
(10) Pub. No.: US 2007/0223120 A1
(43) Pub. Date: Sep. 27, 2007

(54) VEHICULAR INTERIOR REARVIEW MIRROR FOR REAR PASSENGERS

(76) Inventor: Fang-Mei Kuo, Yungkang City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/277,267

(22) Filed: Mar. 23, 2006

(51) Int. Cl. G02B 7/182

(52) U.S. Cl. 359/871

(57) ABSTRACT

The present invention provides a vehicular interior rearview mirror for rear passengers, comprising a mirror inserted in a flange of a mirror housing having a rear pivot for receiving a ball formed at one end of a support bar so that the mirror housing with the mirror is rotatable to a desired angle. A sleeve is fitted in a positioning tube of the support bar. An outside support tube of a headrest of a vehicular seat is snugly inserted through the sleeve fitted in the positioning tube. The support bar is then secured to the support tube by fasteners. Hereby, a rear passenger may turn the mirror housing together with the mirror relative to the ball in order to obtain an optimum viewing angle of the rearview mirror. Thus, the invention facilitates rear pessengers leaving an automobile in a right time without causing hazards by checking the images of rear objects (e.g., approaching cars) reflected by the rearview mirror when a destination is arrived.

### BACKGROUND OF THE INVENTION

1. Field of Invention

The present invention relates to an interior rearview mirrors for a vehicle and more particularly to an interior rearview mirror for rear passengers to see if there are vehicles approaching from the rear before opening a door.

2. Related Art

Conventionally, a car is equipped with exterior rearview mirrors and an interior rearview mirror which is typically located at a joining portion of roof and windshield in the top, front, right (i.e., northeast) direction relative to a driver. This configuration facilitates a driver and a front passenger leaving the car in a right time without causing hazards by checking the images of rear objects (e.g., approaching cars) reflected by the mirrors when a destination is arrived.

However, so far as the present inventor is aware, no disclosures about such rearview mirror. In often times, a rear passenger has to turn his/her head more than 90 degrees to see whether there is any approaching car from the rear. To the worse, the viewing angle may be blocked by objects in the interior of the car. Thus, a need for improvement exists.

### SUMMARY OF THE INVENTION

It is therefore an object of the present invention to provide a vehicular interior rearview mirror for rear passengers, comprising a mirror inserted in a flange of a mirror housing having a rear pivot for receiving a ball formed at one end of a support bar so that the mirror housing with the mirror is rotatable to a desired angle. A sleeve is fitted in a positioning tube of the support bar. An outside support tube of a headrest of a vehicular seat is snugly inserted through the sleeve fitted in the positioning tube. The support bar is then secured to the support tube by fasteners. Hereby, a rear passenger may turn the mirror housing together with the mirror relative to the ball in order to obtain an optimum viewing angle of the rearview mirror. Thus, the invention facilitates rear pessengers leaving an automobile in a right time without causing hazards by checking the images of rear objects (e.g., approaching cars) reflected by the rearview mirror when a destination is arrived.

The above and other objects, features and advantages of the present invention will become apparent from the following detailed description taken with the accompanying drawings.

### BRIEF DESCRIPTION OF THE DRAWINGS

FIG. 1 is an exploded view of a preferred embodiment of an interior rearview mirror according to the invention;

FIG. 2 is a cross-sectional rear view of the assembled rearview mirror according to the invention;

FIG. 3 is a cross-sectional side view of the assembled rearview mirror according to the invention;

FIG. 4 is a perspective view of the assembled rearview mirror to be mounted at a support tube interconnected a headrest and a backrest of a vehicle front seat; and

FIG. 5 is an environmental view of the rearview mirror mounted at the support tube.

### DETAILED DESCRIPTION OF THE INVENTION

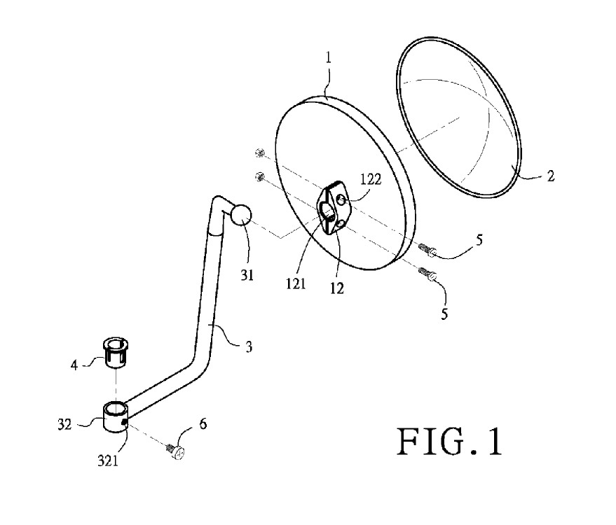

Referring to FIG. 1, an interior rearview mirror for rear passengers in accordance with a preferred embodiment of the invention comprises a mirror housing 1, a mirror 2 and a support bar 3.

The mirror housing 1 can be of various shapes, for example, disc shape, and includes an inward bent front flange 11 for receiving the mirror 2 and a rhombic pivot 12 provided on the back. The rhombic pivot 12 includes spaced left and right halves each including upper and lower transverse through threaded holes 122, and a central cylindrical space 121 defined by the halves.

The mirror 2 is of shape depending on the shape of the mirror housing 1 and can be of curve mirror or flat mirror. In this embodiment, the mirror 2 is a curve mirror, i.e., a wide-angle lens.

The support bar 3 includes a ball 31 formed at an upper bent end and adapted to be inserted into the space 121 and a positioning tube 32 formed at a lower end and including an threaded aperture 321 through its circumference. A sleeve 4 is fitted in the positioning tube 32.

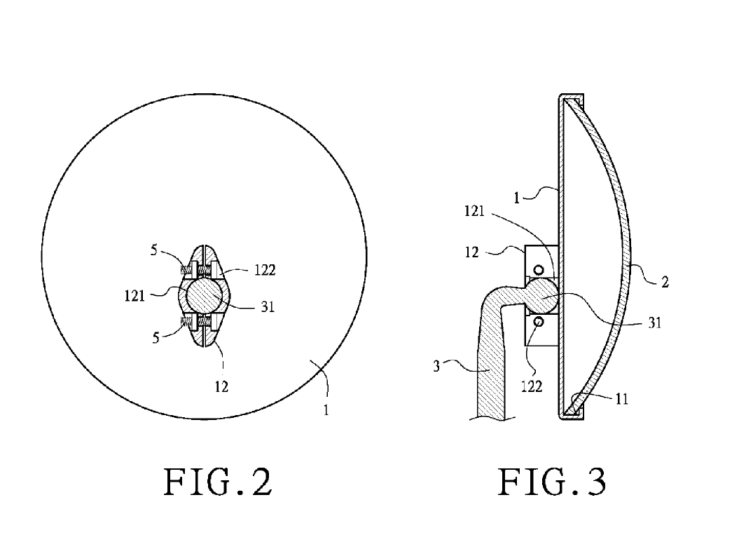

To assemble the rearview mirror assembly, referring to FIGS. 1-3, the mirror 2 is inserted in the flange 11 of the mirror housing 1 and bolt and nut combinations 5 are screwed through the holes 122 to fasten the ball 31 in the space 121.

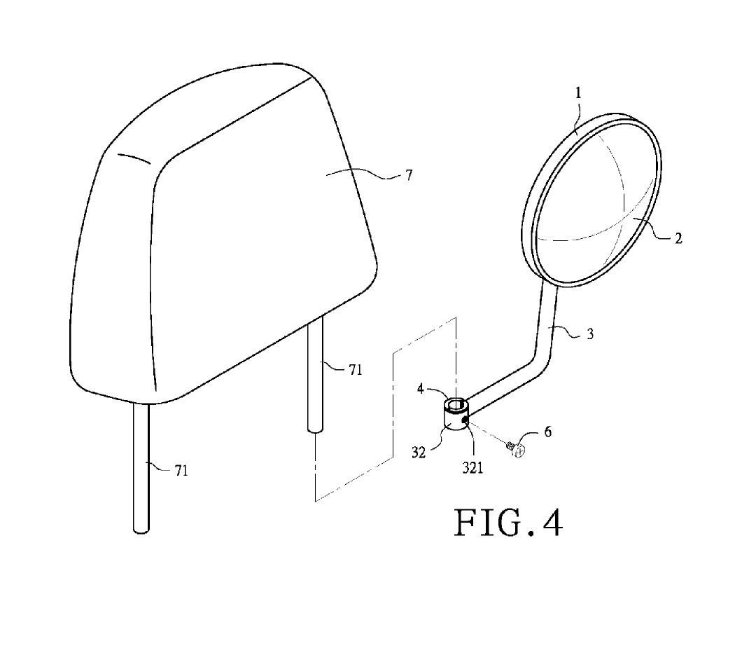

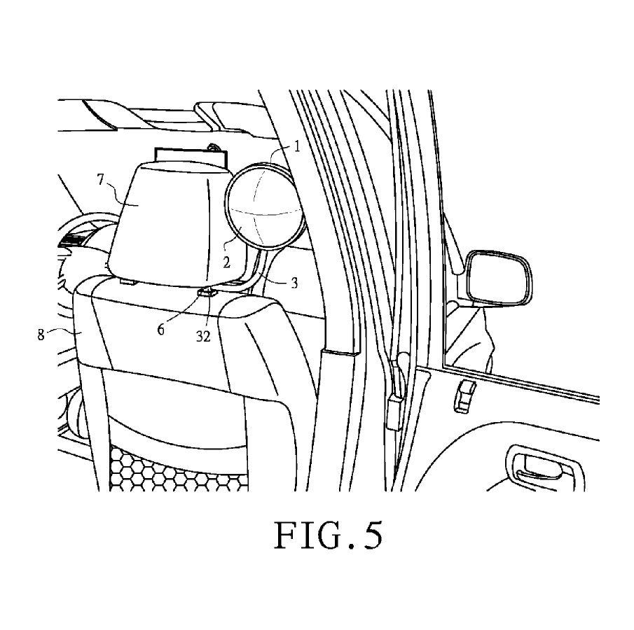

In assembly, referring to FIGS. 4 and 5, after a headrest 7 with a support tubes 71 is detached from a backrest 8, the outside support tube 71 is snugly inserted through the sleeve 4 fitted in the positioning tube 32. Note that the sleeve 4 may have a number of sizes so as to accommodate support tube 71 of different diameters. A fastener 6 is then screwed through the aperture 321 to tightly engage the rearview mirror with the support tube 71 of the headrest 7. As a result, the rearview mirror assembly is mounted at the support tube 71 interconnected the headrest 7 and a backrest 8 of a seat in front of rear passengers (see FIG. 5). A rear passenger may turn the mirror housing 1 together with the mirror 2 relative to the ball 31 in order to obtain an optimum viewing angle of the rearview mirror. Thus, the invention facilitates rear pessengers leaving an automobile in a right time without causing hazards by checking the images of rear objects (e.g., approaching cars) reflected by the rearview mirror when a destination is arrived.

Note that the rearview mirror mounted at the outside support tube 71 interconnected the headrest 7 and the backrest 8 of a front seat in a 5-seat automobile is only a preferred embodiment of the invention. An additional rearview mirror may be mounted at an outside support tube of a seat in front of a second rear seat in a 7-seat or 9-seat automobile.

While the invention herein disclosed has been described by means of specific embodiments, numerous modifications and variations could be made thereto by those skilled in the art without departing from the scope and spirit of the invention set forth in the claims.

What is claimed is:

1. An interior rearview mirror for rear passengers, comprising a mirror housing, a mirror and a support bar, wherein the rearview mirror being mounted on an outside support tube of a headrest of a vehicular seat so that rear passengers can see if there are vehicles approaching before opening a door.

2. The rearview mirror of claim 1, wherein the mirror housing including a rear pivot for receiving a ball formed at one end of the support bar so that the mirror housing with the mirror is rotatable to a desired angle.

3. The rearview mirror of claim 1, wherein the pivot has a rhombic shape and comprises a left half, a spaced right half, each half including upper and lower transverse through holes, and a central cylindrical space defined by the halves with the ball fitted therein such that screwing fasteners through the aligned through holes of the halves will fasten the ball in the space.

4. The rearview mirror of claim 1, wherein the mirror housing can be of disc or square shape.

5. The rearview mirror of claim 1, wherein the mirror can be of curve mirror or flat mirror.

6. The rearview mirror of claim 1, wherein the support bar comprises a positioning tube formed at the other end for being fastened to the support tube of the headrest by fasteners.

7. The rearview mirror of claim 1, wherein a sleeve is fitted in the positioning tube of the support bar.

8. The rearview mirror of claim 1, wherein the sleeve has a number of sizes so as to accommodate the support tube of different diameters.
